(19) United States
(12) Patent Application Publication
(10) Pub. No.: US 2003/0175193 A1
(43) Pub. Date: Sep. 18, 2003

(54) FGD gypsum dewatering improvement through crystal habit modification by carboxylic acids

(76) Inventors: Anders Nimgaard Schultz, Koge (DK); Peter Bo Olsen, Horsholm (DK)

Correspondence Address: BIRCH STEWART KOLASCH & BIRCH, PO BOX 747, FALLS CHURCH, VA, 22040-0747, US

(21) Appl. No.: 10/359,716

(22) Filed: Feb. 7, 2003

Related U.S. Application Data
(60) Provisional application No. 60/354,488, filed on Feb. 8, 2002.

(30) Foreign Application Priority Data
Feb. 8, 2002 (DK) PA 2002 00192

(51) Int. Cl. C01B 17/22

(52) U.S. Cl. 423/243.08

(57) ABSTRACT

A flue gas desulfurization process is disclosed. Specifically the use of carboxylic acids to modify gypsum crystal habit in limestone forced oxidation. The technique is also applicable to other technologies where gypsum is produced as for example in phosphate fertilizer or paper industry.

The present invention relates to dewatering of gypsum in flue gas desulfurization process based on a limestone forced oxidation technology. The dewatering is greatly enhanced by addition of carboxylic acids, preferably citric acid to the scrubbing slurry. It has been found that carboxylic acids serve as a gypsum crystal habit modifier during gypsum crystallization under forced oxidation. I has been found that under normal operating conditions, i.e. when no acid is added, gypsum crystals assume acicular (needle shape) habit and are difficult to dewater since they tend to retain mother liquor in the filter cake. In the presence of carboxylic acids, preferably citric acid, in scrubbing slurry gypsum crystals assume columnar (bulky) habit and can be readily dewatered in the centrifuge up to 90% solids.

In a specific application, the present invention relates generally to flue gas desulfurization processes and specifically to the use of carboxylic acids to modify gypsum crystal habit in limestone forced oxidation. The technique is also applicable to other technologies where gypsum is produced as for example in phosphate fertilizer or paper industry.

### INTRODUCTION TO AND SUMMARY OF THE INVENTION

The deleterious effect of sulfur dioxide from coal and oil fired power plants on health and environment in general has led to the development of flue gas desufurization (FGD) technology. Even though over 100 different processes have been demonstrated great majority of full scale installations use lime/limestone wet scrubbing technique.

The early installations were plagued with scaling problem resulting from oxidation of absorbed sulfite to calcium sulfate (gypsum) that would deposit throughout the absorber, mist eliminator and piping. Gypsum scale typically forms via natural oxidation when the fraction of gypsum in slurry is greater than 15%.

One way to prevent the scaling problem is to blow air into absorbent slurry tank (in-situ forced oxidation) to encourage controlled oxidation outside of absorber. This type of wet scrubbing system, limestone forced oxidation, provides rapid gypsum crystal growth on seed crystals.

The additional benefit of this process is the formation of a stable product, a salable byproduct (which eliminates the need for landfilling) and smaller dewatering equipment. The most common uses of FGD gypsum are for wallboard and cement production.

However, it has been realised, in connection with the present invention, that dewatering of the gypsum produced may be difficult or even impossible due to the shape of the crystals produced. In accordance thereto, the present invention suggests a method of enhancing dewatering and/or rendering possible dewatering of produced crystals by changing the gypsum crystal habit. Thus, in one aspect the present invention relates to a method for enhancing dewatering of gypsum produced under oxidation, preferably being forced, conditions in gas desulfurization system, such as a flue gas desulfurization system, in which system SO₂ in gas, preferably being a flue gas, is absorbed in a scrubbing liquid and neutralized with lime, such as limestone, wherein the sulfite resulting from the neutralization is oxidized to sulfate by addition of an oxidizing agent, preferably air, through one or more spargers and wherein the resulting gypsum crystal habit is modified by addition of one or more carboxylic acids, preferably citric acid, to an absorber tank where the gypsum crystal habit, in the scrubbing slurry with pH range 4-6, is changed from acicular, needle-like to bulky, columnar crystals with crystal size, preferably over 100 microns, thereby producing crystals that are easy to enrich in solids content, preferably in hydroclone underflow, and which are, preferably, finally dewatered in centrifuge, drum or belt vacuum filter.

In particular preferred embodiments the method for enhancing dewatering of gypsum produced under oxidation conditions in gas desulfurization system, comprising the steps of: absorbing system SO₂ gas in a scrubbing liquid; neutralizing said scrubbing liquid with lime, wherein the sulfite resulting from the neutralization is oxidized to sulfate by addition of an oxidizing agent through one or more spargers; modifying a resulting gypsum crystal habit by adding one or more carboxylic acids to an absorber tank where the gypsum crystal habit, in the scrubbing slurry with pH range 4-6, is changed from acicular shaped crystals to bulky, columnar shaped crystals; increasing gypsum crystal concentration in scrubbing slurry using hydroclones, classifiers or thickeners; and dewatering said enriched gypsum crystals in a centrifuge, drum or belt vacuum filter.

In another aspect the invention relates to a device for enhancing dewatering of gypsum produced under oxidation, preferably being forced, conditions in gas desulfurization system, such as a flue gas desulfurization system, in which device SO₂ in gas, preferably being a flue gas, is absorbed in a scrubbing liquid and neutralized with lime, such as limestone, wherein the sulfite resulting from the neutralization is oxidized to sulfate by addition of an oxidizing agent, preferably air, through one or more sparger and wherein the resulting gypsum crystal habit is modified by addition of one or more carboxylic acids, preferably citric acid, to a absorber tank, of the device, where the gypsum crystal habit, in the scrubbing slurry with pH range 4-6, is changed from acicular, needle-like to bulky, columnar crystals with crystal size, preferably over 100 microns, thereby producing gypsum crystals that are easy to enrich in solids content, preferably in hydroclone underflow, and which are, preferably, finally dewatered in centrifuge, drum or belt vacuum filter.

In particular preferred embodiments, the device for enhancing dewatering of gypsum produced under oxidation conditions in gas desulfurization system, comprises: means for absorbing system SO₂ gas in a scrubbing liquid; means for neutralizing said scrubbing liquid with lime, wherein the sulfite resulting from the neutralitzation is oxidized to sulfate by addition of an oxidizing agent through one or more spargers; means for modifying a resulting gypsum crystal habit by adding one or more carboxylic acids to a absorber tank where the gypsum crystal habit, in the scrubbing slurry with pH range 4-6, is changed from acicular shaped crystals to bulky, columnar shaped crystals; means for increasing gypsum crystal concentration in scrubbing slurry using hydroclones, classifiers or thickeners; and means for dewatering said enriched gypsum crystals in a centrifuge, drum or belt vacuum filter.

In the following different findings made in connection with the present invention are put forward in connection with description of preferred embodiments of the invention. Preferred embodiments of the present invention comprise utilisation of or comprise a limestone forced oxidation plant. The main components of limestone forced oxidation plant are preferably:

Limestone preparation system

Absorber with recycle loop

Dewatering equipment

Gas-gas heat exchanger

Waste water treatment plant

The limestone forced oxidation process removes typically over 98% of flue gas sulfur dioxide content applying a wide variety of limestone grades and with high flexibility in operation.

Gypsum dewatering

Gypsum dewatering comprises in general primary and secondary dewatering steps.

A slip stream of gypsum slurry is taken from the absorber tank and is fed to primary dewatering step at the rate to maintain material balance in the process. An objective of a primary dewatering step is to increase gypsum concentration from 15% to between 30-50% by weight. Primary dewatering is typically accomplished by hydroclones, classifiers or thickeners. The underflow from hydroclone with enriched gypsum content is led to the secondary dewatering while the overflow is returned to absorber tank.

The secondary dewatering takes place in centrifuges, rotary or belt vacuum filters. The objective of secondary dewatering is to increase solids content to up 90%. In the case that some undesired compounds as for example chlorides have to be removed from gypsum, the filter cake is washed with fresh water.

Gypsum crystallization

Crystallization is in the present context used preferably to denote a mass transfer operation where solute ions in solution become part of a solid crystal. Supersaturation is a driving force necessary for crystal growth. For growth to occur, the solute must diffuse to the crystal surface and then become integrated into crystal lattice. Growth can therefore be diffusion-rate controlled or integration rate controlled. With low mixing intensity, growth is generally diffusion controlled while with high mixing intensity it becomes integration controlled. The accepted mechanism of solute integration is the screw-dislocation theory where solute is added to the crystal at imperfections in the crystal lattice. The imperfection is continued in a spiral direction, thereby perpetuating its existence.

The chemical reactions taking place in the absorber and absorber tank under limestone forced oxidation are:

SO₂+H₂OδH⁺+HSO₃⁻ (1)

H⁺+HSO₃⁻+½O₂δ2H⁺+SO₄²⁻(partial) (2a)

CaCO₃+2H⁺SO₄²⁻+aqδCaSO₄″2H₂O+CO₂(partial) (3a)

In the absorber the oxygen in the flue gas will partially oxidize sulphite to sulfate (eq. 2a). In the absorber tank, practically all sulfite is converted by in-situ forced oxidation into sulphate (eq. 2b), which in reaction with the calcium of the limestone produces gypsum (eq. 3b).

Chemical reactions taking place in the absorber tank are:

H⁺+HSO₃⁻+½O₂δ2H⁺+SO₄²⁻ (2b)

CaCO₃+2H⁺+SO₄²⁻aqδCaSO₄″2H₂O+CO₂ (3b)

Ambient air is blown into the absorber tank, and complete bi-sulphite oxidation is ensured by maintaining a relatively low pH-value. Gypsum crystallisation takes place under well controlled conditions of supersaturation. A high gypsum concentration in the absorber slurry, controlled pH and appropriate agitation ensures crystallisation operation without scale formation.

The habit of naturally grown crystals from aqueous solution varies depending on the formation conditions. This is because in the presence of foreign ions or molecules, crystal growth rates of different crystallographic surfaces can be increased or decreased.

In pure Ca²⁺ and SO₄²⁻ aqueous solutions, needle like crystals of gypsum are formed which are elongated parallel to the crystallographic c-direction . In the presence of citric acid, the aspect ratio is reduced resulting in the formation of short prisms, where growth on the (010) surface is enhanced. Additionally the growth rate is reduced proportional to the citrate concentration. Experiments have indicated that the enhancement effect is governed by one or both of the following two models:

Adsorption of carboxylic acids on certain crystallographic surfaces

Precipitation of amorphous coatings onto the surface of growing crystals.

One explanation of gypsum crystal habit modification in the presence of citric acid was attributed to weakly adsorbed citrate ions which promote surface nucleation.

As indicated above a problem to be solved in relation to the present invention was the poor or substantially impossible dewatering of gypsum produced as byproduct in flue gas desulfurization process. The FGD process used at a cement manufacturing plant is based on a limestone forced oxidation. In this process gypsum has to be dewatered up to 90% solids in a centrifuge and is subsequently used in cement manufacturing. It has been found that poor dewatering can be caused by the impurities in limestone or by gypsum crystal habit.

In a FGD system limestone composition (in particular impurities), its dissolution rate (reactivity), SO2 absorption rate, forced oxidation of sulfite to sulfate (in presence of catalysts), gypsum crystal growth rate and habit are in a complex dynamic equilibrium.

Furthermore many others process parameters like flue gas composition (namely SO2 content), temperature, slurry composition, solids content, sulfate supersaturation, forced air stoichiometry, presence of iron ions, etc. also play important role.

Under normal operating conditions, i.e. when no acid is added, gypsum crystals assume acicular (needle shape) habit and are difficult to dewater since they tend to retain mother liquor in the filter cake. The liquor is kept between crystals by capillary force.

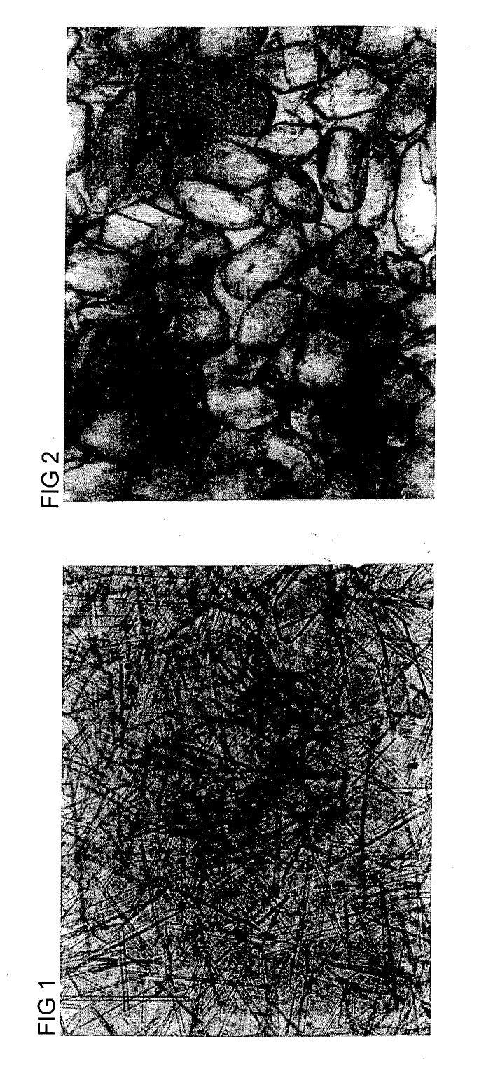

It has been found in connection with the present invention, that dewatering of gypsum in flue gas desulfurization process based on a limestone forced oxidation technology is rendered possible and/or greatly enhanced by addition of carboxylic acids to the scrubbing slurry and thatcarboxylic acids serves as a gypsum crystal habit modifier during gypsum crystallization under forced oxidation. In the presence of citric acid in scrubbing slurry gypsum crystals change from acicular to columnar (bulky) habit as shown in FIGS. 1 and 2.

The size of gypsum crystals is also largely increased and this large, thick, stumpy, regular crystals can be readily dewatered in the centrifuge to 90% solids or more.

One explanation of carboxylic acids activity is that geometric considerations relating the molecular structures of the additive and the crystal structure play an important role in determining the effect of additives on gypsum crystallization.

Acids having two or more carboxylic acid groups per molecule are found to be particular suited in connection with the present invention and these groups should be properly spaced in the molecule—separated by two carbon atoms in aliphatics, occupy alpha position in aromatics, and cis- position in olefins. The shortest Ca ions distance at (111) face of gypsum crystals is approximately the same compared with distance between C atoms of carboxylic groups thus causing growth perpendicular to central axis. In addition to citric acid the other carboxylic acids that are active in gypsum crystal habit change are maleic, succinic, malic, tartaric, tricarballelic, phthalic and nitrilotriacetic.

These carboxylic acid will be active in all FGD processes with forced oxidation. They will be also active in other processes where gypsum is crystallized like in phosphate fertilizer and paper industry.

In preferred embodiments of the invention, each of the one or more carboxylic acids are characterised by that at least two carboxylic groups are properly spaced in the molecule, preferably separated by two carbon atoms in aliphatics, occupy alpha position in aromatics, and cis- position in olefins.

Each of the one or more carboxylic acids is preferably selected from the group consisting of citric, maleic, succinic, malic, tartaric, tricarballelic, phthalic and nitrilotriacetic acids or a combination thereof. Furthermore, each of the one or more carboxylic acids when added is preferably added as a salt. Additionally, the carboxylic acids or their salts is preferably added in the amount of 20 to 2000 ppm, such as between 100-1500 ppm, preferably in the amount of 250-1000 ppm in scrubbing slurry.

In preferred embodiments of the invention, the pH range preferably from 4-6.5, preferably at pH 5.8 in the scrubbing slurry.

The change of gypsum habit is preferably accomplished in a scrubbing slurry at flue gas adiabatic saturation temperature of 50-70° C., such as between 55-65° C.

In preferred embodiments of the invention, the gypsum with changed crystal habit is preferably formed by oxidation of sulfite with oxygen in air introduced to scrubbing liquid containing carboxylic acids through sparger system.

Preferably, the slip stream of scrubbing slurry liquor with modified gypsum crystal habit from absorber tank may be dewatered in a two stage system consisting of hydroclone(s) as a first stage and centrifuge, drum or belt vacuum filter as a second stage.

Furthermore, the filtrate separated from filter cake in dewatering equipment like centrifuge, drum or belt vacuum filter is preferably returned to an absorber tank to preserve carboxylic acids or their salts.

Preferably, hydroclone overflow having reduced solids content characterized by gypsum crystals population of smaller size than in underflow may be returned to an absorber tank so that crystals can grow further and only hydroclone underflow having increased solids content characterized by gypsum crystals population with larger size is taken to the secondary dewatering stage.

The gypsum crystals with modified habit may preferably be taken from absorber tank as a scrubbing slurry slip stream and may first be enriched to 30-50% solids in the hydroclone underflow and may then be taken to the secondary dewatering stage and preferably be enriched to filter cake with over 90% solids.

Preferably and advantageously, gypsum crystals with modified habit dewatered to over 90% solids may be used in cement manufacturing or in wallboard production.

Particular preferred embodiments of invention relate to cement plant. Such cement plants comprises preferably a device according to the second aspect of the present invention. Preferably, the cement plant may be adapted to carry a method according to the first aspect of the present invention.

In the following preferred embodiments of the present invention will be present in connection with the accompanying drawings, showing preferred embodiments of the invention, in which:

FIG. 1 shows gypsum crystals without citric acid

FIG. 2 shows gypsum crystals with citric acid

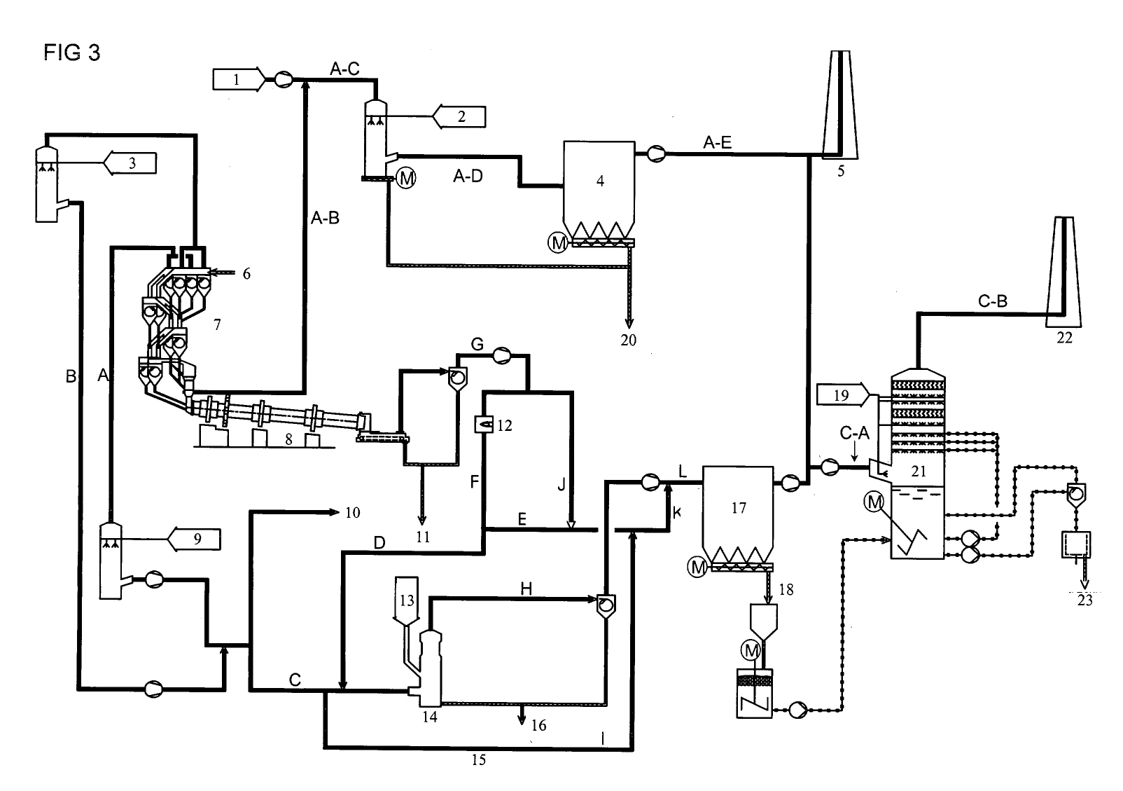

FIG. 3 shows schematically a cement plant with FGC system

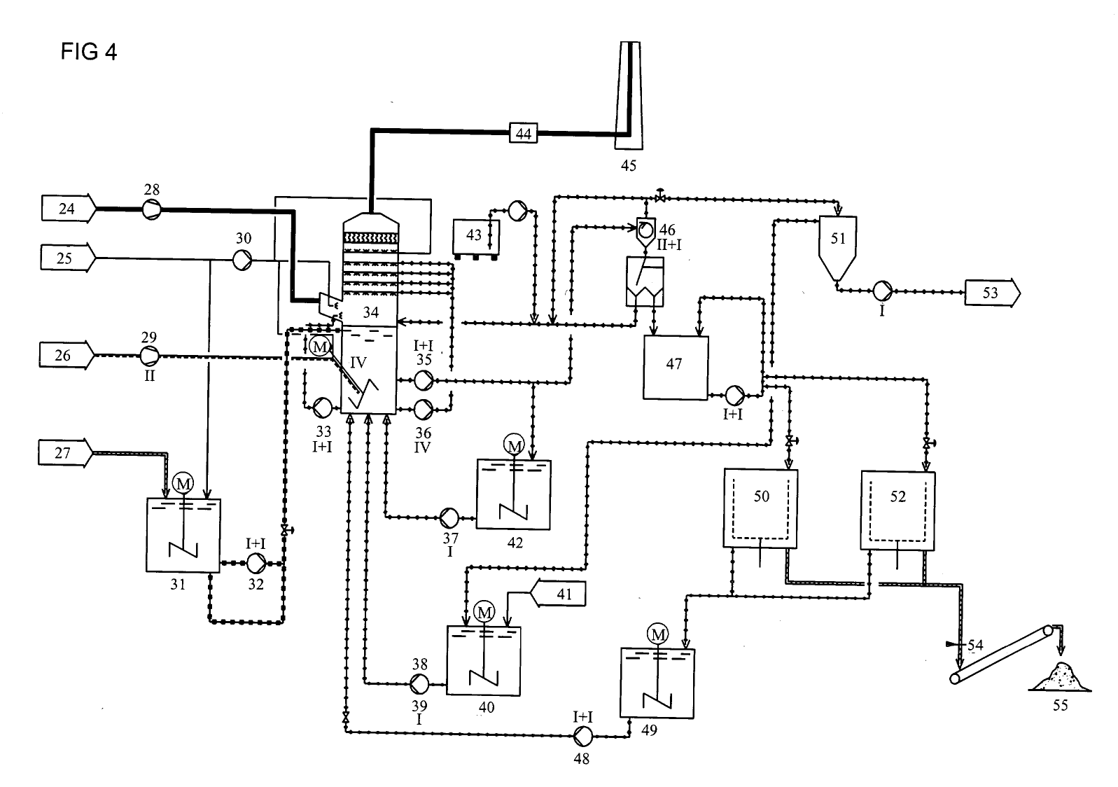

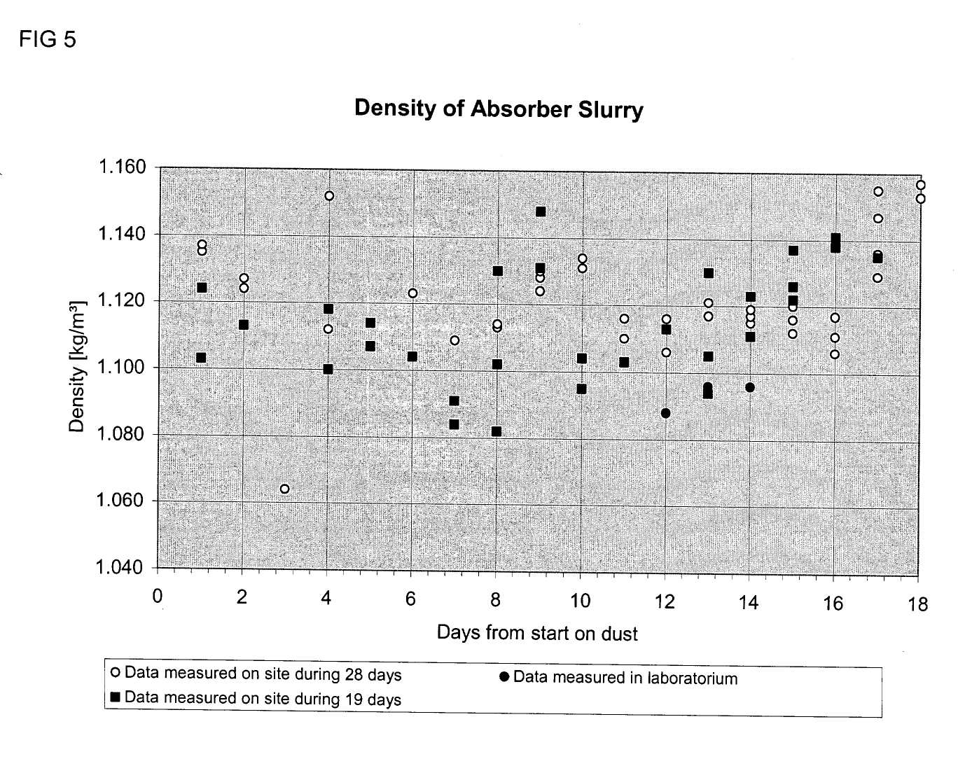

FIG. 4 shows schematically a FGD system with gypsum crystal habit modification

FIG. 5 is a graph showing density of absorber slurry

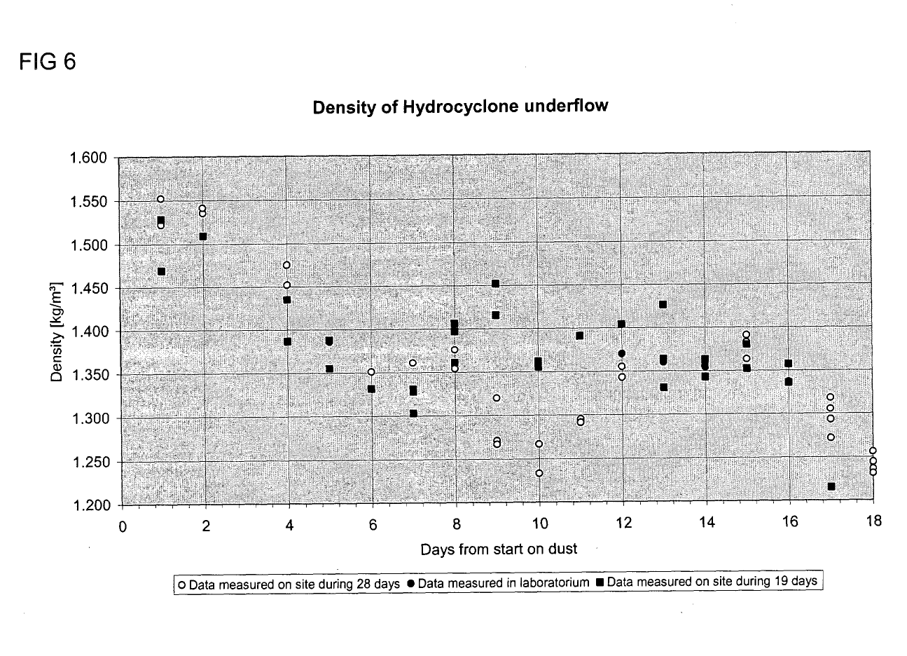

FIG. 6 is a graph showing density of Hydrocyclone underflow

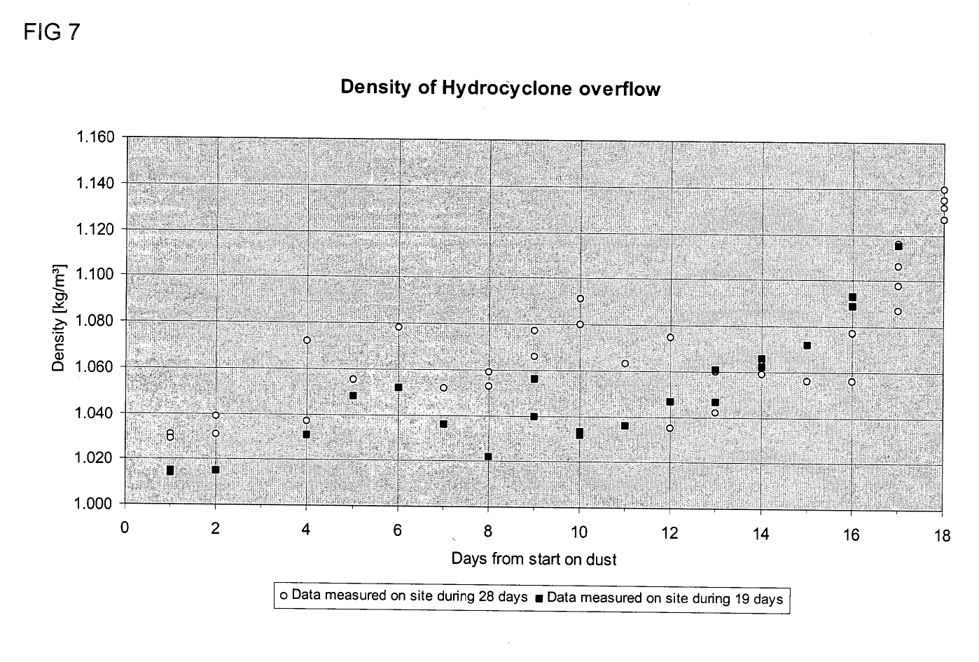

FIG. 7 is a graph showing density of Hydrocyclone overflow

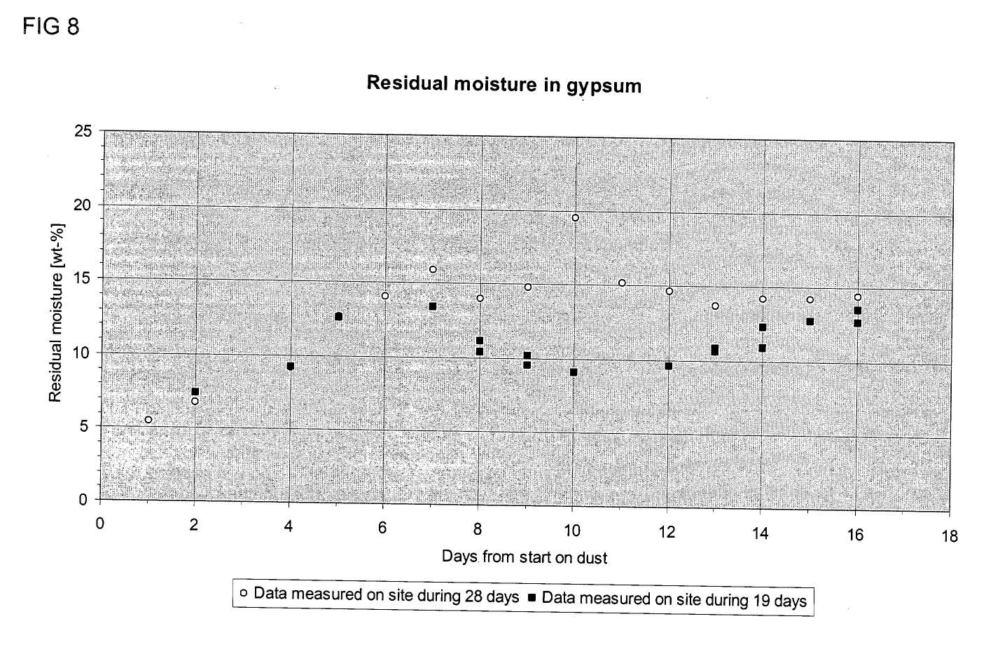

FIG. 8 is a graph showing residual moisture in gypsum

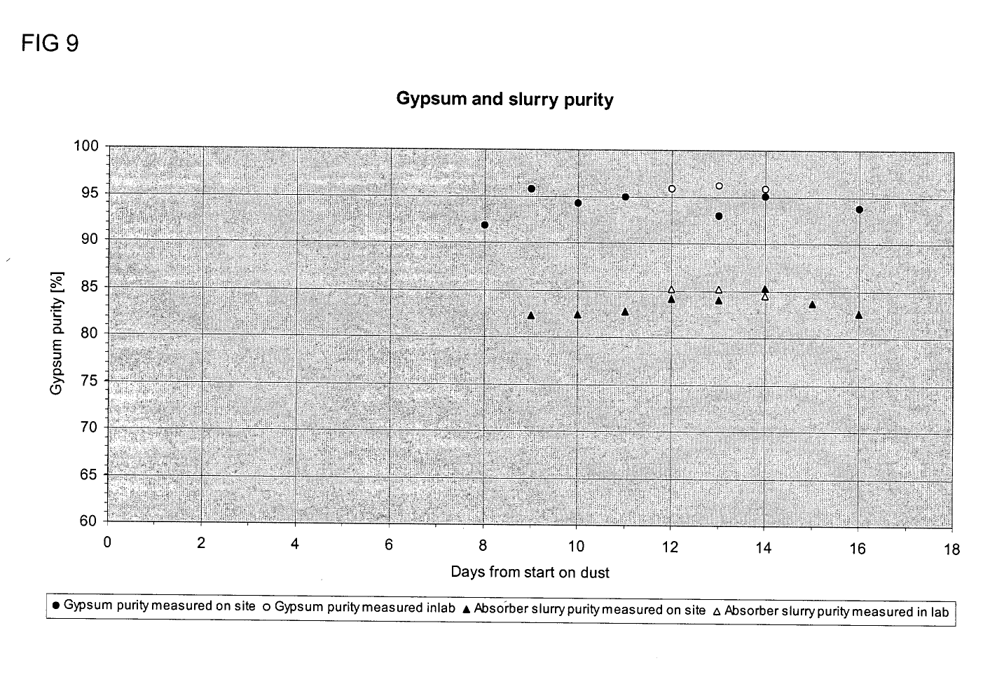

FIG. 9 is a graph showing gypsum and absorber slurry purity and

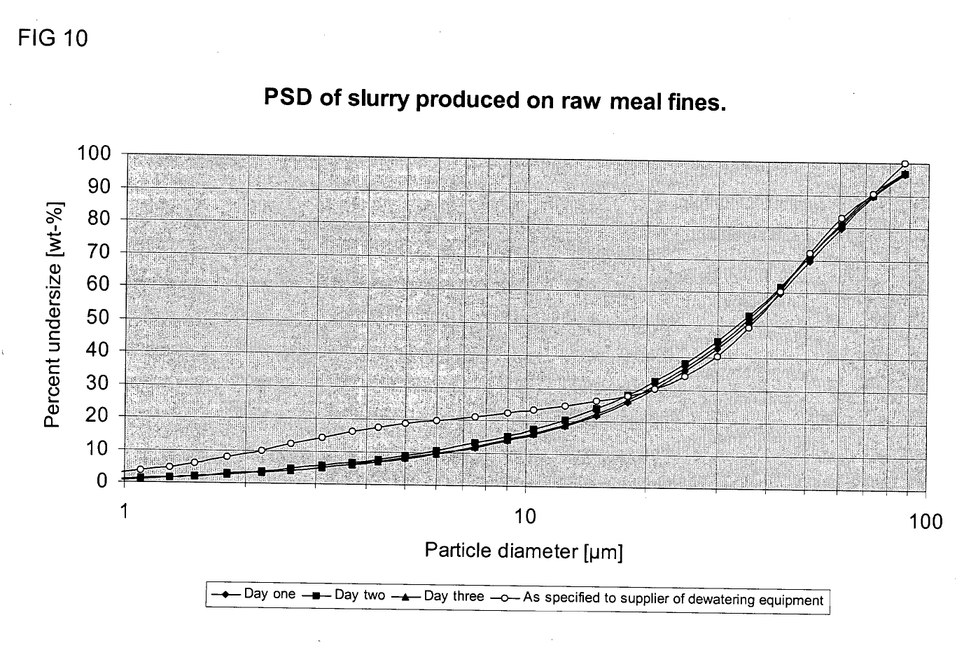

FIG. 10 is a graph showing gypsum particle size distribution of slurry produced on raw meal fines.

### DESCRIPTION OF PREFERRED EMBODIMENTS

A preferred embodiment of the present invention relates to a flue gas desulfurization plant treating gases from cement manufacturing plant. The primary objective of the FGD plant is to remove sulfur dioxide by wet scrubbing of the flue gas from rotary kiln and alkali bypass. In addition, a portion of the dust and most of the halide gases are also removed.

The flue gas desulfurization plant consists of the following major sub-systems:

Absorbent feeding and preparation system

Absorption section

Dewatering section

These sub-systems are described in the following pages, while FIGS. 3 and 4 show the process flow diagrams.

FIG. 3 shows the schematic of cement plant where gas streams from alkali bypass, and rotary kiln are introduced to wet scrubbing system.

FIG. 4 shows process flow diagram for flue gas desulfurization system based on limestone forced oxidation where citric acid is added for gypsum crystal modification.

Absorbent feeding and preparation system

Following is an equipment list for the major components required for the absorbent feed and preparation system:

Absorbent mixing tank. Quantity I

Agitator for absorbent slurry mixing, Quantity I

Slurry dosing pump, Quantity II, I running+I standby′

In the mixing tank the baghouse dust consisting of raw material fines is mixed with process water, forming an approximately 40% w/w limestone slurry.

The required quantity of slurry mixture is dosed into the absorber by the absorbent dosing pump based upon pH of the absorber tank liquor.

Absorption section

Following is an equipment list for the major components required for the absorption section:

Absorber tower, Quantity I

Absorber slurry tank including oxidation section, Quantity I

Mist eliminator, Quantity II

Oxidation air blower, Quantity I

Absorber tank agitator, Quantity IV

Lance air sparger (LAS), Quantity IV

Absorber Reaction Tank-Integral to absorber, Quantity I

Absorber sump agitator, Quantity I

Absorber sump pump, Quantity I

Hold-up tank, Quantity I

Hold-up tank agitator, Quantity II

Hold-up tank pump, Quantity I

Citrate storage tank

Citrate tank agitator

Citrate dosage pump

Flue gas from the kiln and alkali bypass is combined into a booster fan and introduced into the absorber system. Pre-conditioning spray nozzles are provided at the absorber inlet to quench the gas prior to entering the absorber. Once the flue gas enters the absorber the flue gas temperature is at adiabatic saturation. The absorber has three re-circulation stages which remove SO₂. A portion of the dust and virtually all the halide gases are removed as well.

The absorber section consists of an open spray tower equipped with three spray levels, two mist eliminator sections and an integrated reaction tank complete with forced oxidation.

The flue gas enters the tower where it comes in contact with the three spray layers. Subsequently, the flue gas flows upwards, countercurrent to the sprayed slurry from the absorber tower re-circulation pumps.

The chemical reactions in the absorber are as follows:

SO₂ (gas) SO₂ (liquid)

SO₂ (liquid)+H₂ [symbol] H⁺+HSO₃

H⁺+HSO₃+½O₂ [symbol] 2H⁺+SO₄²⁻(partial)

CaCO3+2H++SO₄²⁻+aq [symbol] CaSO₄.2H₂O+CO₂(partial)

The absorber tank includes side-mounted agitators which together with the recirculation pump prevent settling of gypsum in the absorber reaction tank.

The air for forced oxidation of sulfite to gypsum is introduced to the tank through specially designed sparger that works in conjunctions with agitators to distribute the air for intimate contact with scrubbing liquor.

After the flue gas flow upwards through the spray levels the flue gas has been cleaned of acid gases. Entrained droplets are removed by a two stage mist eliminator located at the top of the absorber.

The following liquids are added directly to the absorber tank:

Liquid from the absorber sump

Wash water from the mist eliminator

Wash water from the air sparger

Make-up water

Quench water

Absorbent slurry mixture

Citrate solution

Density control of the dewatering section ensures that the concentration of solids in the absorber slurry is maintained at a value of approx. 20% - 25% w/w.

Citrate solution is added to the absorber tank from citrate storage tank via dosage pump to maintain citrate concentration necessary to change gypsum crystal habit.

To remove entrained mist from the flue gas horizontal chevron type mist eliminators are provided. The mist eliminators are washed intermittently by process water.

In order to prevent plugging during shutdowns, the slurry must be drained from the inlet and outlet pipelines of the pumps and discharged to the absorber sump. Also in the event of extended shutdowns the pump may be stopped, and consequently the systems are drained again.

At shutdowns for inspection, etc. the slurry in the absorber tank is pumped to the hold-up tank. Before the absorber is started, the slurry is returned to the absorber. The gypsum crystals are needed in the process to eliminate the risk of scaling in the absorber system.

The evaporation of water in the absorber is compensated by adding quench water, water in the slurry, water added through the oxidation system, and water in the mist eliminator wash.

Waste water is purged out of the system from the collecting tank. The purpose of the purge is to avoid accumulation of impurities in the system.

Dewatering section

Following is an equipment list for the major components required for the dewatering section:

Bleed pump, Quantity II, I running/I standby

Flow Diverter, Quantity I

Centrifuge Feed Tank, Quantity I

Centrifuge Feed Tank Agitator, Quantity I

Hydrocyclone, Quantity I

Centrifuge Feed Pump, Quantity II, I running/I standby

Centrifuge, Quantity II, I running/I standby

Filtrate tank, Quantity I

Filtrate Feed Tank Agitator, Quantity I The slurry solid concentration in the absorber tank is suitable for dewatering the gypsum to 90% or more solids content by means of a two stage dewatering system consisting of primary and secondary steps. The slip stream of scrubbing slurry is taken to dewatering at the rate to maintain material balance in the FGD process.

Primary dewatering takes place in the hydrocyclone. The underflow from the hydrocyclone battery with enriched solids content to 30-50% is sent to the centrifuge for secondary dewatering.

An important role of hydroclone is to segregate solids by their particle size. The underflow with enriched solids content has gypsum crystal population with larger size. The overflow with reduced solids content has gypsum crystal population with smaller size and it contains some unreacted limestone.

The overflow of the hydrocyclone battery is returned to the absorber so that gypsum crystals can grow further and unreacted limestone can be reused.

The filtrate from the centrifuge is also returned to absorber tank to preserve citrate solution.

The dewatered gypsum is stored and is used in cement manufacturing.

Case history

A full scale FGD system has been installed at a cement plant where by-product gypsum is used in cement production. The schematics of the installation are shown in FIGS. 3 and 4 while the process description and list of equipment is presented above.

The key process parameters are:

Flue gas flow rate, ACFM: 998,985

Flue gas temperature, ° F.: 460

Pressure, in. WG: +30

SO₂ concentration, ppm, wet: 1043

Selected desired performance:

SO₂ removal efficiency, %: >90

Gypsum solids content, %: >90

The limestone with varying quality from a local quarry is used as absorbent for SO₂ removal.

The installation had no problem in meeting SO₂ removal efficiency but the desired gypsum dewatering could not be achieved under normal operating conditions.

A microscopic examination of gypsum crystals showed that they had an acicular habit as shown in FIG. 1. The proposed explanation for poor dewatering was that the acicular crystals tend to retain mother liquor between crystals by capillary force.

Based on these observations if was found that some sort of crystal habit modifier accumulated in the slurry during the operation. The modifier could be organic, in organic, water soluble or water insoluble.

An attempt was made to start FGD system operation with addition of gypsum seed crystals with columnar shape that was known to dewater well. However after the couple of gypsum solids inventory turnovers gypsum crystals assumed acicular shape and were difficult to dewater.

When limestone was replaced with lime as absorbent gypsum crystal habit changed to columnar and gypsum could be dewatered to desired 90% solids. However due to the much higher cost of lime as absorbent this could not be a permanent solution to dewatering problem.

Throughout testing program to solve the gypsum dewatering problem the following parameters were measured and recorded.

1 Absorber slurry density.

2 Crystal habit observed in microscope.

3 Hydro cyclone (HC) underflow density.

4 Hydro cyclone overflow density.

5 Residual moisture of gypsum.

6 Calcium sulphate purity of gypsum and absorber slurry.

FIG. 5 shows the absorber density during the two test periods. As can be seen the density in the absorber has been controlled very close to the preferred operating range of 1,110-1,120 kg/m³.

The density in the underflow of the hydro cyclones (HC) is the best indicator for the crystal habit. If the underflow density starts to decrease without obvious reason like change in feed density, temperature, etc., it is an indication that the crystal size or habit of the gypsum crystals are changing. In the test conducted, the HC underflow was followed very closely. FIG. 6 shows the changes in HC underflow as a function of time for one test period.

Based on the observations made in both periods, it is likely, that the steady state density of the hydro cyclone underflow will be 1350-1400 kg/m³ with the raw meal fines combined with the addition of citric acid as absorbent.

As seen from the figure, the density in the overflow varies between 1,015 and 1,090 kg/m³ during the operation.

As seen in FIG. 8, the residual moisture in the produced gypsum for the combined operation on raw meal fines and citric acid is slightly higher than the guaranteed 10 wt-%. It is also noted that the trend of the residual moisture follows the trend in the hydro cyclone overflow density.

Based on the above observations, it seems as if the residual moisture in the gypsum is correlated with the density of the hydro cyclone overflow, that again is a function of the crystal habit. It seems likely that the fraction of plate-like crystals has been larger for the last test period than for the first one. If the last statement is correct, it indicates that the production of plate-like crystals strongly influences the residual moisture in the final gypsum product.

Before it was realised that a change in crystal habit was the cause of the gypsum dewatering problem, the focus was on the steady state composition of the gypsum slurry. It was speculated that too many impurities could be the reason for the high water content of the gypsum cake. This hypothesis was investigated during the last test period. The result is shown in FIG. 9.

As seen from FIG. 9, the agreement between the measurements performed on site and in the laboratorium is good. As can be seen, the purity is rather constant during the whole test period and, as expected, the purity of the produced gypsum is higher than the absorber slurry. It can be concluded that an accumulation of the impurities is not the cause of the gypsum dewatering problem.

FIG. 10 shows the particle size distribution of slurry produced in the absorber. The desired PSD is indicated by the “As specified to the supplier of dewatering equipment” curve. The difference between the three PSD's are very small, indicating that stable operation has been achieved.

In order to change gypsum crystal habit with limestone an absorbent citric acid was added to the absorber reaction tank. Upon numerous tests with different citric acid brands and salts with various concentrations, scrubbing slurry pH value and limestone quality the conditions were achieved where gypsum crystals assumed columnar habit shown in FIG. 2 and was readily dewatered to over 90% solids.

It is envisaged, that the flue gas disulfurization process based on limestone forced oxidation with addition of carboxylic acids for improved dewatering through gypsum crystal habit modification is applicable to electric power generating plants using any fuels containing sulfur in the quantities that will result in SO₂ emissions that will exceed regulations. The method according to the present invention was originally developed specifically for an FGD system in cement industry where gypsum could not be dewatered to desired degree. However, the method is also applicable to all other industrial processes requiring flue gas desulfurization.

The enhancement of gypsum dewatering through gypsum crystal habit modification is also applicable to industries where gypsum is produced and has to be dewatered. The major such industries are phosphate fertilizer plants, paper industry, oil refineries, waste water treatment, etc.

In FIGS. 3 and 4 the following legends are used

| | |
|---|---|
| 1. | AIR |
| 2. | WATER |
| 3. | WATER |
| 4. | ALKALI BY-PASS |
| 5. | STACK |
| 7. | PREHEATER CALCINATOR |
| 10. | TO COAL MILL |
| 11. | KLINKER |
| 12. | FUEL |
| 13. | RAW MATERIAL |
| 14. | RAW MILL |
| 15. | RAW MILL BY-PASS |
| 16. | RAW MEAL |
| 17. | RM FILTER |
| 18. | RM DUST |
| 19. | WATER |
| 20. | WASTE |
| 21. | ABSORBER |
| 22. | STACK |
| 23. | GYPSUM |
| 24. | FLUE GAS BAG HOUSE |
| 25. | WATER |
| 26. | AIR |
| 27. | RAW MEAL |
| 28. | BOOSTER FAN |
| 29. | OXIDATION BLOWER |
| 30. | WATER PUMP |
| 31. | ABSORBENT MIXING AND STORAGE TANK |
| 32. | ABSORBENT DOSING PUMP |
| 33. | QUENCHER PUMP |
| 34. | ABSORBER |
| 35. | BLEED PUMP |
| 36. | RECIRCULATION PUMP |
| 37. | HOLD-UP PUMP |
| 38. | ABSORBER |
| 39. | SUMP PUMP |
| 40. | ABSORBER SUMP |
| 42. | HOLD-UP TANK |
| 43. | CITRATE |
| 46. | HYDROCOLON |
| 47. | CENTRIFUGE FEED TANK |
| 48. | FILTRATE PUMP |
| 49. | FILTRATE TANK |
| 50. | CENTRIFUGE 1 |
| 51. | THICKNER TANK |
| 52. | CENTRIFUGE 2 |
| 53. | PURGE |
| 54. | FLS/CLI |
| 55. | GYPSUM |

1. A method for enhancing and/or enabling dewatering of gypsum produced under oxidation, preferably being forced, conditions in gas desulfurization system, such as a flue gas desulfurization system, in which system SO₂ in gas, preferably being a flue gas, is absorbed in a scrubbing liquid and neutralized with lime, such as limestone, wherein the sulfite resulting from the neutralization is oxidized to sulfate by addition of an oxidizing agent, preferably air, through one or more sparger and wherein the resulting gypsum crystal habit is modified by addition of one or more carboxylic acids, preferably citric acid, to a absorber tank where the gypsum crystal habit, in the scrubbing slurry with pH range 4-6, is changed from acicular, needle-like to bulky, columnar crystals with crystal size, preferably over 100 microns, thereby producing crystals that are easy to enrich in solids content, preferably in hydroclone underflow, and which are, preferably, finally dewatered in centrifuge, drum or belt vacuum filter.

2. A method according to claim 1, wherein each of the one or more carboxylic acids are characterised by that at least two carboxylic groups are properly spaced in the molecule, preferably separated by two carbon atoms in aliphatics, occupy alpha position in aromatics, and cis- position in olefins.

3. A method according to claim 1, wherein each of the one or more carboxylic acids is selected from the group consisting of citric, maleic, succinic, malic, tartaric, tricarballelic, phthalic and nitrilotriacetic acids or a combination thereof.

4. A method according to claim 1, wherein each of the one or more carboxylic acids when added is added as a salt.

5. A method according to claim 1, wherein the carboxylic acids or their salts is added in the amount of 20 to 2000 ppm, such as between 100-1500 ppm, preferably in the amount of 250-1000 ppm in scrubbing slurry.

6. A method according to claim 1, wherein pH range from 4-6.5, preferably at pH 5.8 in the scrubbing slurry.

7. A method according to claim 1, wherein the change of gypsum habit is accomplished in a scrubbing slurry at flue gas adiabatic saturation temperature of 50-70° C., such as between 55-65° C.

8. A method according to claim 1, wherein the gypsum with changed crystal habit is formed by oxidation of sulfite with oxygen in air introduced to scrubbing liquid containing carboxylic acids through sparger system.

9. A method according to claim 1, wherein the slip stream of scrubbing slurry liquor with modified gypsum crystal habit from absorber tank is dewatered in a two stage system consisting of hydroclone(s) as a first stage and centrifuge, drum or belt vacuum filter as a second stage.

10. A method according to claim 1, wherein filtrate separated from filter cake in dewatering equipment like centrifuge, drum or belt vacuum filter is returned to an absorber tank to preserve carboxylic acids or their salts.

11. A method according to claim 9, wherein hydroclone overflow having reduced solids content characterized by gypsum crystals population of smaller size than in underflow is returned to absorber tank so that crystals can grow further and only hydroclone underflow having increased solids content characterized by gypsum crystals population with larger size is taken to the secondary dewatering stage.

12. A method according to claim 9, wherein gypsum crystals with modified habit are taken from absorber tank as a scrubbing slurry slip stream and are first enriched to 30-50% solids in the hydroclone underflow which is then taken to the secondary dewatering stage and enriched to filter cake with over 90% solids.

13. A method according to claim 1, wherein gypsum crystals with modified habit dewatered to over 90% solids are used in cement manufacturing or in wallboard production.

14. A device for enhancing and/or enabling dewatering of gypsum produced under oxidation, preferably being forced, conditions in gas desulfurization system, such as a flue gas desulfurization system, in which device SO₂ in gas, preferably being a flue gas, is absorbed in a scrubbing liquid and neutralized with lime, such as limestone, wherein the sulfite resulting from the neutralization is oxidized to sulfate by addition of an oxidizing agent, preferably air, through one or more sparger and wherein the resulting gypsum crystal habit is modified by addition of one or more carboxylic acids, preferably citric acid, to a absorber tank, of the device, where the gypsum crystal habit, in the scrubbing slurry with pH range 4-6, is changed from acicular, needle-like to bulky, columnar crystals with crystal size, preferably over 100 microns, thereby producing gypsum crystals that are easy to enrich in solids content, preferably in hydroclone underflow, and which are, preferably, finally dewatered in centrifuge, drum or belt vacuum filter.

15. A cement plant comprising a device according to 14.

16. A cement plant adapted to carry out the method defined in claim 1.
